(19) United States
(12) Patent Application Publication
(10) Pub. No.: US 2010/0326398 A1
(43) Pub. Date: Dec. 30, 2010

(54) ROTOR-PISTON INTERNAL COMBUSTION ENGINE

(76) Inventor: Viktor Prokopovych Yaroshenko, Apostolove (UA)

Correspondence Address: Mikhailyuk Sorokolat and Partners;Attn Viktor Yaroshenko, 46 Bobruiskaya Str, Kharkov, 61054, UA

(21) Appl. No.: 12/918,486

(22) PCT Filed: Feb. 12, 2009
(86) PCT No.: PCT/IB2009/050570

§ 371 Date: Aug. 20, 2010

(30) Foreign Application Priority Data
Feb. 22, 2008 (UA) A 2008 02266

(51) Int. Cl. F02B 53/10; F01C 1/28

(52) U.S. Cl. 123/205

(57) ABSTRACT

The present invention relates to positive displacement pneumatic machines, and more particularly the present invention relates to internal combustion engines.

A rotor-piston internal combustion engine of the invention comprises a body comprising a main cylindrical cavity in which a rotor-piston is concentrically mounted, the rotor-piston comprising radial protrusions and radial recesses on the peripheral surface thereof, the radial protrusions and radial recesses forming, in conjunction with substantially cylindrical inner walls of the body, a plurality of closed segmental cavities; combustion chambers comprising nozzles to inject fuel and spark plugs; three-blade separating rotors installed in the combustion chambers with the possibility of discrete turn through 120° with stops; and gas distribution devices comprising inlet channels and outlet channels.

The advantages of a rotor-piston internal combustion engine of the invention are high smoothness of the torque, division of the segmental cavities of the rotor-piston without employing separating vanes and reduction of gas-dynamic losses.

### TECHNICAL FIELD

The present invention relates to positive displacement pneumatic machines, and more particularly the present invention relates to internal combustion engines.

### BACKGROUND ART

Rotary engines are the alternative to conventional 4-stroke internal combustion engines. Usually a rotary engine contains a rotor-piston, which revolves in a body and feeds air or a fuel-air mixture into a combustion chamber where the fuel-air mixture burns and creates a combustion stroke by the energy of combustion products (see, for example, U.S. Pat. No. 3,040,530, 1962; U.S. Pat. No. 3,579,733, Int. Cl. F02B, 1996; U.S. Pat. No. 5,579,733, 1996; U.S. Pat. No. 6,241,499, 2001; U.S. Pat. No. 6,530,357, 2003, among others).

U.S. Pat. No. 6,530,357, 2003, to Yaroshenko, V. P., discloses a rotary internal combustion engine including a body that comprises a main cylindrical cavity. The main cylindrical cavity comprises a rotor-piston that is concentrically mounted therein. The rotor-piston comprises radial protrusions and radial recesses on its peripheral surface, which define, in conjunction with body inner walls, a plurality of closed segmental cavities. The pairs of combustion chambers are disposed symmetrically outside the main cylindrical cavity each combustion chamber comprising a pair of channels in the form of an inlet channel and an outlet channel through which the combustion chamber communicates with the main cylindrical cavity. An opening of the outlet channel of each channel pair to the main cylindrical cavity is shifted relative to an opening of the inlet channel of this channel pair to the main cylindrical cavity in the direction of rotor-piston rotation. A radially movable separation vane is installed between these openings, which abuts against the peripheral surface of the rotor-piston. Both inlet channels and outlet channels are provided with controlled valves of gas distribution mechanism.

Disposed symmetrically between the pairs of the inlet channels and outlet channels are pairs of intake channels and exhaust channels. An opening of the intake channel of each said pair to the inner cylindrical cavity is shifted relative to an opening of the exhaust channel of this channel pair to the main cylindrical cavity in the direction of rotor-piston rotation. A radially movable separation vane is installed between these openings, which abuts against the peripheral surface of the rotor-piston.

In this engine, the rotor-piston rotates about its axis in the main cylindrical cavity performing the following cycle in each segmental cavity defined by the relief surface of the rotor-piston and of the inner walls of the main cylindrical cavity. When a protrusion of the rotor-piston passes the opening of the intake channel, the volume of the segmented cavity begins to increase, and the intake stroke takes place therein. During this stroke, the air mixture enters said increasing segmental cavity through the intake channel.

The given segmental cavity is then cut off from the intake channel by the next following protrusion of the rotor-piston, and the content thereof is pushed out to the combustion chamber through the inlet channel of the combustion chamber and an open inlet valve in this channel. A valve in the outlet channel of the combustion chamber is closed, and the air mixture compression stroke takes place. At this time, in the adjacent combustion chamber, the combustion of the fuel-air mixture earlier pumped therein takes place, and the combustion products enter, through the outlet channel and the open outlet valve of this chamber, the preceding segmental cavity thereby performing the combustion stroke. At this time, the inlet valve of this combustion chamber is closed.

Once the ridge of the rotor-piston has passed the separating vane between the inlet channel and outlet channel, the compressed fuel-air mixture in this combustion chamber is ignited and the combustion products enter the segmental cavity after the separating vane through the outlet channel and the open outlet valve—the combustion stroke occurs. At this time, the inlet valve of this combustion chamber is closed.

When this ridge has passed the opening of the exhaust channel, the combustion products within this segment are displaced outwards by the next following ridge which runs on the separating vane between the intake channel and the exhaust channel—the exhaust stroke occurs.

Thus, if this engine comprises the rotor-piston with six ridges and four pairs of combustion chambers, then 24 combustion strokes occurs during one revolution of the rotor-piston thereby a high smoothness of torque is ensured. In addition, the compression process in this engine is carried out into the combustion chamber substantially completely cleared of combustion products at an initial pressure equal or close to the ambient pressure, i.e., to the atmospheric pressure, thereby a high efficiency of using the combustion products energy of the fuel-air mixture is achieved.

However, this engine comprises a large number of controlled valves arranged in a non-linear manner. This complicates materially its design and requires a significant power consumption to operate the engine. So, an engine with four pairs of combustion chambers must comprise 16 valves the control whereof requires at least 4 distribution shafts or other devices disposed around the engine body. In addition, the combustion of fuel-air mixture takes place simultaneously with the discharge of combustion products into the segmental cavity this resulting in reduction in the efficiency of using the fuel-air mixture for a portion thereof is captured by the combustion products and carried away from the zone which has optimal combustion conditions.

Ukrainian utility model patent No. 25334, 2007, discloses an improved Yaroshenko engine which includes a body that comprises a main cylindrical cavity, rotor-piston which is concentrically mounted in the body. The rotor-piston comprises radial protrusions and radial recesses on its peripheral surface. These protrusions and recesses form, in conjunction with body inner walls, closed segmental cavities. At least two combustion chambers are disposed symmetrically outside the main cylindrical cavity each combustion chamber comprising a pair of channels in the form of an inlet channel and an outlet channel through which the combustion chamber communicates with the main cylindrical cavity. An opening of the outlet channel of each pair of the channels into the main cylindrical cavity is shifted relative to an opening of the inlet channel of this pair of the channels to the main cylindrical cavity in the direction of rotor-piston rotation. A radially movable separation vane is installed between these openings, which abuts against the peripheral surface of the rotor-piston. Exhaust channels and intake channels are disposed in pairs and symmetrically between the pairs of the inlet channels and outlet channels. An opening of the intake channel of each pair of the inlet and outlet channels into the main cylindrical cavity is shifted relative to an opening of the exhaust channel of this pair to the main cylindrical cavity in the direction of rotor-piston rotation. A radially movable separation vane is installed between these openings, which abuts against the peripheral surface of the rotor-piston. Each of the combustion chambers is made in the form of three sections isolated from each other, each section being capable of passing, cyclically and discretely, through the following phases:
Intake phase when the cavity is connected to the inlet channel,
Combustion phase when the cavity is closed, and
Exhaust phase when the cavity is connected to the outlet channel.

In accordance with a preferred embodiment of the engine, the combustion chamber sections are formed by an inner surface of a distributing cylindrical cavity and by the surfaces of recesses between ridges of a distributing rotor. The distributing rotor is coupled with a 120° cyclic discrete turn drive and is disposed within the distributing cylindrical cavity which communicates with the cylindrical cavity of the body through the inlet channel and the outlet channel. The opening of the inlet channel to the distributing cavity is shifted relative to the opening of the outlet channel to this cavity in the direction of the distributing rotor. Located between these openings is the top of the partition between the recesses of the distributing rotor when the latter is in a stationary state.

The principal disadvantage of this engine is the necessity to employ movable separating vanes to divide the segmental cavities of the rotor-piston. The providing of a tight abutment of these vanes against the surface of the rotor-piston constitutes a rather difficult problem the solution whereof would result in a substantial complication of the engine and rise in the cost thereof. Another disadvantage is that, in operation, the vanes are subject to great side loads while they must move freely in their pockets, this bringing additional difficulties in the implementation of such a design. Yet another disadvantage is the employment of rather long inlet channels, outlet channels, exhaust channels, and intake channels; during gas flow through these channels, gas-dynamic losses occur which result in engine power losses.

### DISCLOSURE OF INVENTION

### Technical Solution

The object of the invention is to provide a rotor-piston internal combustion engine of a simpler, more reliable and more energy-saturated design that would require neither separation vanes nor long channels for gas flow motion.

The object of the invention is achieved with the engine comprising a body that comprises a main cylindrical cavity in which a rotor-piston is concentrically mounted. The rotor-piston comprises radial protrusions and radial recesses on its peripheral surface. The radial protrusions and radial recesses forms, in conjunction with body cylindrical inner walls, a plurality of closed segmental cavities. In addition, the body comprises combustion chambers comprising nozzles to inject fuel and spark plugs. The combustion chambers comprise three-blade separating rotors installed therein with the possibility of discrete turn through 120° with stops. Disposed between the combustion chambers are gas distribution devices that comprise inlet channels and outlet channels. This engine is characterized by that:
each combustion chamber is configured as an incomplete substantially cylindrical cavity that is open to the main cylindrical cavity where the former crosses the latter,
the side surfaces of the separating rotors are made concave with their radius of curvature being equal to that of the main cylindrical cavity,
each separating rotor is installed so that, in its stop position, one of the side surfaces thereof forms a continuous extension of the inner surface of the main cylindrical cavity,
each gas distribution device is configured as an incomplete substantially cylindrical cavity that is open to the main cylindrical cavity where the former crosses the latter,
each gas distribution device comprises a three-blade separating rotor installed therein with the possibility of discrete turn through 120° with stops,
the side surfaces of the distributing rotors are made concave with their radius of curvature being equal to that of the main cylindrical cavity, and
each distributing rotor is installed so that, in its stop position, one of the side surfaces thereof forms a continuous extension of the inner surface of the main cylindrical cavity.

In such design, both separating rotors and distributing rotors whose tops slide directly over the surface of the rotor-piston performs the functions of separating vanes. In addition, the cavities of combustion chambers and gas distribution devices communicate with the segmental cavities of the rotor-piston directly through wide openings with minimum gas-dynamic losses during gas flow through these openings.

### DESCRIPTION OR DRAWINGS

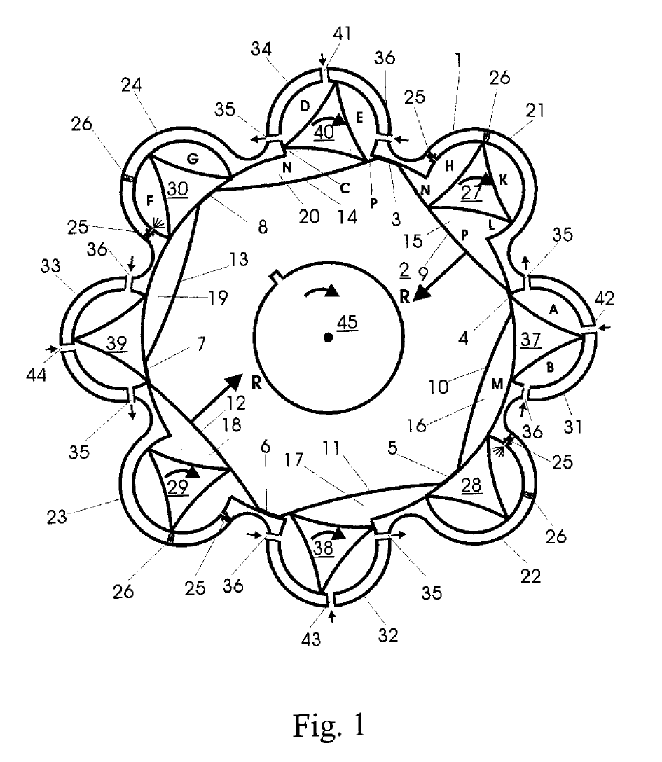

The present invention will now be explained in more detail with reference to FIGS. 1 to 3 which show a rotor-piston internal combustion engine in accordance with the present invention with its rotor-piston being in different angular positions.

### INDUSTRIAL APPLICABILITY

A rotor-piston internal combustion engine in accordance with the present invention includes a body 1 that comprises a main cylindrical cavity in which a rotor-piston 2 is concentrically mounted. The rotor-piston 2 comprises six radial protrusions 3-8 and six radial recesses 9-14 on its peripheral surface. The six radial protrusions 3-8 and the six radial recesses 9-14 form, in conjunction with cylindrical inner walls of the body 1, a plurality of closed segmental cavities 15-20 (FIGS. 1 to 3).

Four combustion chambers 21-24 are disposed concentrically around the main cylindrical cavity of the body 1. The combustion chambers 21-24 are configured as incomplete cylindrical cavities that are open to the main cylindrical cavity where the former crosses the latter. The combustion chambers 21-24 are provided with nozzles 25 to inject fuel and spark plugs 26. The combustion chambers 21-24 comprise three-blade separating rotors 27-30 installed therein which are connected to a device that turns them through 120° with stops. The turns of the separating rotors are synchronized with rotor-piston rotation so that when a protrusion of the rotor-piston slides over the side surface of a separating rotor, the latter remains immovable while when a radial recess of the rotor-piston is under the separating rotor, the separating rotor turns about its axis and its top slides without gap over the surface of the recess of the rotor-piston.

Similarly, four gas distribution devices 31-34 are disposed concentrically around the main cylindrical cavity of the body 1 in between the combustion chambers 21-24. The gas distribution devices 31-34 are also configured in the form of incomplete cylindrical cavities open to the main cylindrical cavity of the body 1 where the former crosses the latter. The gas distribution devices 31-34 are provided with outlet channels 35 and inlet channels 36. The gas distribution devices 31-34 comprise three-blade distributing rotors 37-40 installed within their cavities, which are connected to a device that turns them through 120° with stops. The turns of the distributing rotors are also synchronized with rotor-piston rotation as described above for the separating rotors.

The side surfaces of both separating rotors 27-30 and distributing rotors 37-40 are made concave with their radius of curvature being equal to that of the main cylindrical cavity. Each rotor 27-30 and 37-40 is installed so that, in its stop position, one of the side surfaces thereof forms a continuous extension of the inner surface of the main cylindrical cavity of the body 1. The gas distribution devices 31-34 may also be provided with scavenge channels 41-44.

The rotor-piston 2 is coupled with a power take-off shaft 45.

In operation, the rotor-piston 2 rotates within the main cylindrical cavity of the body 1. The protrusions 3-8 of the rotor-piston 2 slide over the inner cylindrical surface of the main cylindrical cavity of the body 1 and abut tightly against this surface so that to eliminate or minimize gas exchanges between the segmental cavities 15-20.

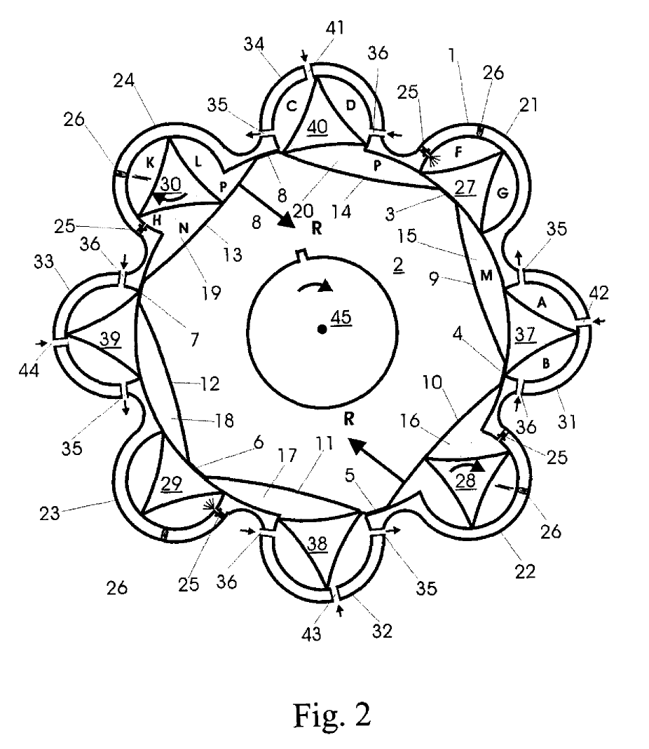

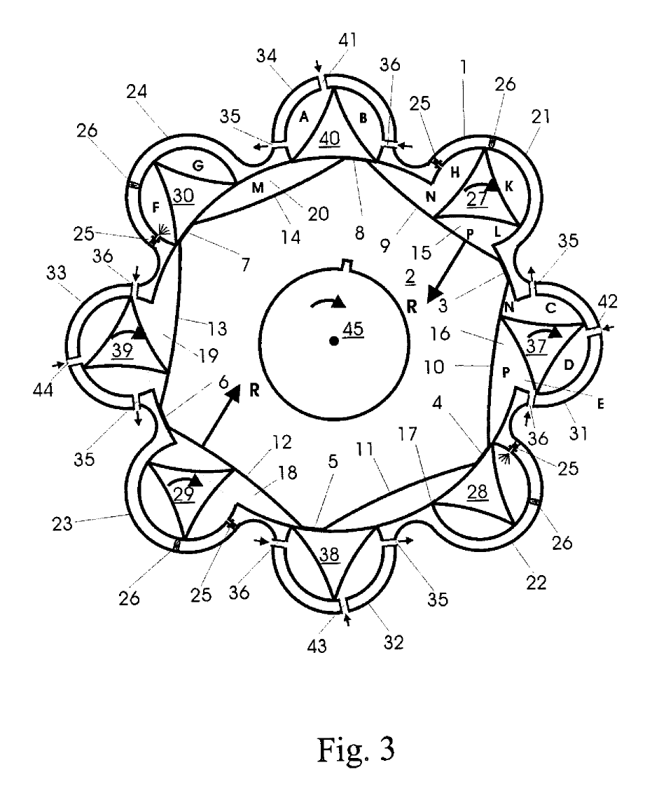

Each of the separating rotors 27-30 turns with stops which turns are synchronized with rotor-piston 2 rotation so that, at any time, either one of the tops of a separating rotor or one of the side surfaces thereof abuts tightly against the surface of the rotor-piston 2 with no gas now through the contact area. This process may be described in more detail as follows: In the stop state, each of the separating rotors 27-30 is in such position that one of the side surfaces thereof forms a continuous extension of the inner surface of the main cylindrical cavity of the body 1, and one of the radial protrusions 3-8 of the rotor-piston 2 slides over this extension. The separating rotors 28 and 30 in FIGS. 1 and 3, and the separating rotors 27 and 29 in FIG. 2 are in the stop state.

In the stop state, the separating rotors 27-30 divide the combustion chamber cavities into cavities F and G isolated from the segmental cavities of the rotor-piston 2. The segmental cavities 15-20 of the rotor-piston 2 define, in conjunction with the inner walls of the main cylindrical cavity of the body 1 and the side surfaces of the separating rotors and of the distributing rotors, closed cavities M.

At the point of time when the protrusion of the rotor-piston 2 which slides over the side surface of a separating rotor left completely this side surface, the separating rotor start turning (see the separating rotors 27 and 29 in FIGS. 1 and 3, the separating rotors 28 and 30 in FIG. 2) during which turning the top of the separating rotor slides with no gap over the surface of a recess of the rotor-piston 2. The separating rotor turns through 120° and stops when the leading edge of the next following protrusion of the rotor-piston 2 reaches the combustion chamber; and this radial protrusion slides then over the side surface of the separating rotor which, at this point of time, has come to static position. During the turn of the separating rotor, it forms, along with the combustion chamber walls:
an increasing chamber H;
an isolated chamber K; and
a decreasing chamber L (the volume whereof is decreasing).

At the same time, increasing chambers P and decreasing chambers N are formed bounded by the adjacent surfaces of rotor-piston 2, of a separating rotor, and of the main cylindrical cavity of the body 1.

Similarly, each of the distributing rotors 37-40 turns with stops which turns are synchronized with rotor-piston 2 rotation so that, at any time, either one of the tops of a distributing rotor or one of the side surfaces thereof abuts tightly against the surface of the rotor-piston 2 with no gas flow through the contact area. This process may be described in more detail as follows: In the stop state, each of the distributing rotors 37-40 is in such position that one of the side surfaces thereof forms a continuous extension of the inner surface of the main cylindrical cavity of the body 1, and one of the radial protrusions 3-8 of the rotor-piston 2 slides over this extension. The distributing rotors 37 and 39 in FIG. 1, the distributing rotors 37 and 39 in FIG. 2, the distributing rotors 38 and 40 in FIG. 3 are in the stop state.

In their static position, the distributing rotors 37-40 divide the gas distribution device chamber cavities into cavities A and B isolated from the segmental cavities of the rotor-piston 2.

At the point of time when the radial protrusion of the rotor-piston 2 which slides over the side surface of a distributing rotor left completely this side surface, the distributing rotor start turning (see the distributing rotors 40 and 38 in FIG. 1, the distributing rotors 37 and 39 in FIG. 3) during which turning the top of the distributing rotor slides with no gap over the surface of a recess of the rotor-piston 2. The distributing rotor turns through 120° and stops when the leading edge of the next following protrusion of the rotor-piston 2 reaches the recess within which this distributing rotor is disposed; and this radial protrusion slides then over the side surface of this distributing rotor. During the turn of the distributing rotor, it forms, along with the gas distribution device chamber walls:
an increasing chamber C;
an isolated chamber D; and
a decreasing chamber E.

The engine depicted in FIGS. 1-3 has a symmetric design; therefore, substantially identical processes take place in any diametrally opposite members thereof. For example, the positions of rotors within the gas distridution devices 32 and 34 and the processes therein would always be substantially identical. This is also the case in the event of the second pair of the gas distridution devices 31 and 33, the pair of the combustion chambers 21 and 23, and the pair of the combustion chambers 24 and 26. Now only processes related to one of the representatives of such pairs will be described this being enough sufficiently to understand the operation of the engine in accordance with the invention as a whole.

Referring now to FIG. 1, the separating rotor 30 of the combustion chamber 24 is in a static state, and the protrusion 8 of the rotor-piston 2 slides over the side surface thereof. The combustion chamber 24 is divided into two isolated cavities F and G. The cavity F is filled with fresh air to which fuel is injected via the nozzle 25 to produce a fuel-air mixture. The cavity G under high pressure is filled with fuel-air mixture combustion products.

After the combustion chamber 24, the gas distribution device 34 comprising the distributing rotor 40 is disposed. FIG. 1 shows the position of the distributing rotor 40 at the initial stage of turn through 120° when one of the tops thereof has already started sliding over the surface of the recess 14. The outlet channel 35, the inlet channel 36, and the scavenge channel 42 of the gas distribution device 34 are open; in the increasing cavity D, there take place scavenging and the filling of fresh air, while the decreasing cavity E is filled with fresh air and this fresh air starts entering the increasing cavity P of the segmental cavity 14. The decreasing cavity N of the segmental cavity 14 is filled with waste combustion products which are pressed out to the increasing cavity C of the gas distribution device 34.

The distributing rotor 27 in FIG. 1 makes a turn and one of the tops thereof slides over the surface of the radial recess 9 dividing it into cavities N and P. The cavity of the combustion chamber 21 is divided by the distributing rotor 27 into an increasing cavity H, a closed cavity K, and a decreasing cavity L. The cavities N and H communicate to each other and are filled with air to prepare the next portion of fuel-air mixture. In the cavity K, the combustion of the fuel-air mixture takes place initiated by a spark plug 26 during which the cavity K is filled with combustion products under high pressure. The cavities L and P are also filled with fuel-air mixture combustion products under high pressure received from the combustion of the previous portion of fuel-air mixture in this combustion chamber. The pressure applied by the combustion products to the area of the radial recess 9 which bounds the cavity P produces a force R the direction whereof is shifted from the axis of the rotor-piston 2. As a result, a torque is produced which drive the rotor-piston 2 in motion, i.e., the combustion stroke takes place. The substantially identical processes take place in the diametrally opposed combustion chamber 29 and, as a result, the torque is doubled.

The gas distribution device 31 is disposed after the combustion chamber 21. The distributing rotor 37 in FIG. 1 is motionless and forms cavities A and B. The cavity A is scavenged of combustion products and is prepared to receive fresh air. The cavity B is injected with fresh air at that time.

FIG. 2 shows the positions of the engine elements when the rotor-piston has turned forward through around 23°. The distributing rotor 30 in the combustion chamber 26 is under rotation; the combustion products at a high pressure from the cavity L enter the cavity P of the segmental cavity 19 and perform the combustion stroke as described above. Fresh air from the decreasing cavity N is pressed out to the increasing cavity H of the combustion chamber. In the cavity K, the combustion of the fuel-air mixture takes place initiated by the spark plug 26 during which this cavity is filled with combustion products at high pressure.

The distributing rotor 40 of the gas distribution device 34 in FIG. 2 is completing its turn through 120°. The discharge of waste combustion and scavenge products from the cavity C is ending and the pumping of fresh air to the cavity D begins. The cavity P of the segmental cavity 20 has nearly achieved its maximum volume and is filled with fresh air. Following the scavenging of this cavity with fresh air, it will be filled, at the end of discharge process, with substantially clean air.

The separating rotor 27 of the combustion chamber 21 is in a static state. Fuel is injected to the cavity F through the nozzle 25 whilest the cavity G is filled with combustion products at high pressure.

The distributing rotor 37 of the gas distribution device in FIG. 2 is in a static state and forms cavities A and B. The cavity A is substantially free of combustion products and is prepared to receive fresh air. The injection of fresh air into the cavity at that time has been completed or is completing.

FIG. 3 shows the positions of the engine elements when the rotor-piston has turned forward through further around 24°. The separating rotor 30 in the combustion chamber 26 is in a static state. The cavity F is filled with fresh air and fuel is injected thereinto through the nozzle 25. The segmental cavity 20 is filled with waste combustion products which are transported to the gas distribution device 34 for a subsequent discharge.

The distributing rotor 40 of the gas distribution device 34 in FIG. 3 is in a stationary state. The cavity A of the gas distribution device 34 is substantially free of the waste combustion products and the injection of fresh air into the cavity B is completing.

The separating rotor 27 of the combustion chamber 21 is at the middle stage of its turn through 120°. Fresh air is passed into the increasing cavity H from the decreasing cavity N of the segmental cavity 15 whilst, in the cavity K, the process of the combustion of the fuel-air mixture and of the filling of this cavity with combustion products at high pressure is completing. The combustion products which were contained in the decreasing cavity L flow into the increasing cavity P of the segmental cavity 15 and perform the combustion stroke as described above.

The distributing rotor 37 of the gas distribution device 31 in FIG. 3 is at the final stage of its turn through 120°. The waste combustion products from the decreasing cavity N of the segmental cavity 16 enter the increasing cavity C of the gas distribution device 31 and discharge therefrom. The cavity D is substantially free of the waste combustion products and fresh air from the decreasing cavity E passes into the increasing cavity P of the segmental cavity 16.

When the rotor-piston rotates further, the above processes repeat cyclically. During one revolution of the rotor-piston, 12 pair combustion strokes uniformly distributed in time take place in the engine, thereby a high smoothness of the torque is achieved. Rotating rotors of the combustion chambers and gas distribution devices ensure the division of the segmental cavities of the rotor-piston without employing separating vanes having disadvantages inherent thereto. Finally, gas exchange between functional elements of the engine takes place through short, wide openings in which gas-dynamic losses are minimized.

The preceding detailed description is not intended to be limited to the specific forms set forth herein, but on the contrary, it is intended to cover such alternatives, modifications, and equivalents devised by those skilled in the art, as can be reasonably included within the spirit and scope of the appended claims. For example, the engine may comprise a different number of combustion chambers and gas distribution devices or may have the rotor-piston with a different number of protrusions and recesses; the engine may be equipped with conventional means of scavenging gas distribution device chambers, with means to improve the quality of fuel-air mixture preparation, with means to optimize the fuel-air mixture combustion process, and with other similar means.

What is claimed is:

1. A rotor-piston internal combustion engine, the engine comprising:
a body that comprises a main cylindrical cavity,
in which a rotor-piston is concentrically mounted, said rotor-piston comprising radial protrusions and radial recesses on the peripheral surface thereof, said radial protrusions and radial recesses forming, in conjunction with substantially cylindrical inner walls of the body, a plurality of closed segmental cavities, combustion chambers comprising nozzles to inject fuel, and spark plugs, three-blade separating rotors installed in said combustion chambers with the possibility of discrete turn through 120° with stops, and
gas distribution devices comprising inlet channels and outlet channels,
characterized in that
each combustion chamber is configured as an incomplete substantially cylindrical cavity, which is open to the main cylindrical cavity where the former crosses the latter,
the side surfaces of the separating rotors are made concave with their radius of curvature being equal to that of the main cylindrical cavity, each separating rotor is installed so that, in its stop position, one of the side surfaces thereof forms a continuous extension of the inner surface of the main cylindrical cavity,
each gas distribution device is configured as an incomplete substantially cylindrical cavity, which is open to the main cylindrical cavity where the former crosses the latter,
each gas distribution device comprises a three-blade separating rotor installed therein with the possibility of discrete turn through 120° with stops, the side surfaces of the distributing rotors are made concave with their radius of curvature being equal to that of the main cylindrical cavity, and each distributing rotor is installed so that, in its stop position, one of the side surfaces thereof forms a continuous extension of the inner surface of the main cylindrical cavity.
